(19) United States
(12) Patent Application Publication
(10) Pub. No.: US 2008/0122136 A1
(43) Pub. Date: May 29, 2008

(54) Polymethylmethacrylate With a Nacreous Effect

(75) Inventors: Volker Mende, Darmstadt (DE); Wolfgang Scharnke, Darmstadt (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Roehm GmbH, Darmstadt (DE)

(21) Appl. No.: 11/813,975

(22) PCT Filed: Jan. 14, 2006
(86) PCT No.: PCT/EP06/00292

§ 371 Date: Jul. 13, 2007

(30) Foreign Application Priority Data
Feb. 17, 2005 (DE) 10 2005 007 481.2

(51) Int. Cl. C08F 8/00; D01D 5/12

(52) U.S. Cl. 264/210.1; 525/170

(57) ABSTRACT

(EN) The invent on relates to polymethylmethacrylate with a nacreous effect. (DE) Die Erfindung betrifft Polymethylmethacrylat mit Perlglanzeffekt.

The invention relates to polymethyl methacrylate with pearl-luster effect.

The object of coloring plastics has substantially been achieved satisfactorily by industry. The usual method of increasing the quality of appearance of plastics adds dyes or pigments to the polymer mixture. In this process, the materials can be completely mixed with the additives, or else surfaces alone can be modified.

In the acrylic sheet sector by way of example, there is a range of colorants available permitting homogeneous coloring of acrylic sheet in almost any desired shade.

DE 3023964 has previously proposed a process for producing, in polymerization cells responsible for shaping, zones comprising colorant in acrylic and methacrylic resins in the vicinity of the surfaces during the course of polymerization of the monomers and prepolymers which form the resins, by firstly applying, In the form of a layer, a colorant homogeneously dispersed in a binder to the wall of the polymerization cell responsible for shaping, the binder here being soluble, or at least swellable, in the liquid resin or its precursors and polymerization taking place in a manner known per se after charging of the monomers and/or prepolymers to be polymerized

EP 0553845 describes a polymer mixture composed of a thermoplastic polyester resin (A) and of a resin (B) incompatible therewith The amounts added of component (B) are from 2 to 50% by weight. The materials here are polyolefin resins, poly (meth)acrylic resins, polystyrene resins, polycarbonate resins, or polyamide resins. An anisotropic luster is observed. There are indications that the optical effect is lost at mixing ratios outside the stated ratios.

Anisotropic luster or opalescent effect are terms used when materials have a pearl-luster effect which is also attended by an in-depth effect

In view of the prior art cited here it was an object of the present invention to provide a process which can produce a semifinished product which without admixture of dyes or pigments has a pearl-luster effect.

The object is achieved via a process for production of plastics products with pearl-luster effect by means of extrusion or injection molding characterized in that a mixture composed of from 5 to 35% of polyethylene terephthalate glycol (PBTG) and from 65 to 95% of polymethyl methacrylate (PMMA) and, if appropriate from 0.01 to 5.0% of auxiliaries and additives is prepared and the mixture is extruded and, if appropriate formed or injection-molded to give a plastics product

Surprisingly, it has been found that a pearl-luster effect can be detected in the resulting molding composition when incompatible polymers, such as polyethylene terephthalate glycol are added to polymethyl methacrylate. Contrary to the teaching of EP 0553845, this pearl-luster effect is also detected at mixing ratios of less than 50% of polyethylene terephthalate glycol in polymethyl methacrylate. Preference is given to use of mixtures with from 15 to 25%, particularly preferably 20%, of PETS in PMMA.

The inventive mixture can also comprise further auxiliaries and additives alongside from 5 to 35% of polyethylene terephthalate glycol (PETS, and from 65 to 95% of polymethyl methacrylate (,PMMA

Polymethyl methacrylates are generally obtained via free-radical polymerization of mixtures which comprise methyl methacrylate. These mixtures generally comprise at least 65% by weight, preferably at least 80% by weight, based on the weight of the monomers, of methyl methacrylate.

These mixtures for production of polymethyl methacrylates can also comprise other (meth)acrylates copolymerizable with methyl methacrylate The expression (meth)acrylates comprises methacrylates and acrylates and mixtures of the two. These monomers are well known. Among them are inter alia, (meth)acrylates which derive from saturated alcohols, e.g. methyl acrylate, ethyl (meth)acrylate, propyl (meth)acrylate, n-butyl (meth)acrylate, tert-butyl (meth)acrylate, pentyl (meth)acrylate and 2-ethylhexyl (meth)acrylate; (meth)acrylates which derive from unsaturated alcohols, e.g. oleyl (meth)acrylate, 2-propynyl (meth)acrylate, allyl (meth)acrylate, vinyl (meth)acrylate; and also aryl (meth)acrylates, such as benzyl (meth)acrylate or phenyl (meth)acrylate, and in each case the aryl radicals here can be unsubstituted or can have up to four substituents;

Cycloalkyl (meth)acrylates, such as 3-vinylcyclohexyl (meth)acrylate, bornyl (meth)acrylate; hydroxyalkyl (meth)acrylates, such as 3-hydroxypropyl (meth)acrylate, 3,4-dihydroxybutyl (meth)acrylate, 2-hydroxyethyl (meth)aacrylate, 2-hydroxypropyl (meth)acrylate;

Glycol di(meth)acrylates, such as 1,4-butanediol (meth)acrylate,

(meth)acrylates of ether alcohols, e.g. tetrahydro-furfuryl (meth)acrylate, vinyloxyethoxyethyl (meth)-acrylate; amides and nitriles of (meth)acrylic acids e.g. N-3-dimethylaminopropyl) (meth)acrylamide, N-(diethylphoshono)(meth)acrylamide,

1-methacryloylamido-2-methyl-2-propanol; sulfur-containing methacrylates, such as ethylsufinylethyl (meth)acrylate, 4-thiocyanuatobutyl (meth)acrylate ethylsulfonylethyl (meth)acrylate, thiocyanatomethyl (meth)acrylate, methylsulfinylmethyl (meth)acrylate,

bis((meth)acryloyloxyethyl) sulfide; polyfunctional (meth)acrylates, such as trimethyloyl-propane tri(meth)acrylate.

The compositions to be polymerized can comprise not only the (meth)acrylates described above but also other unsaturated monomers which are copolymerizable with methyl methacrylate and with the abovementioned (meth)-acrylates. Among these are, inter alia, 1-alkenes, such as 1-hexene, 1-heptene; branched alkenes, such as vinylcyclohexane, 3,3-dimethyl-1-propene, 3-methyl-1-di-isobutylene, 4-methyl-1-pentene; acrylonitrile; vinyl esters, such as vinyl acetate; styrene, substituted styrenes having an alkyl substituent in the side chain, e.g. α-methylstyrene and α-ethylstyrene, substituted styrenes having an alkyl substituent on the ring, e.g. vinyltoluene and p-methylstyrene, halogenated styrenes, such as monochlorostyrenes, dichlorostyrenes, tribromo-styrenes and tetrabromostyrenas;

heterocyclic vinyl compounds, such as 2-vinylpyridine, 3-vinylpyridine, 2-methyl-5-vinylpyridine, 3-ethyl-4-vinylpyridine, 2,3-dimethyl-5-vinylpyridine, vinyl-pyrimidine, vinylpiperidine, 9-vinylcarbazole, 3-vinyl-carbazole, 4-vinylcarbazole, 1-vinylimidazole, 2-methyl-1-vinylimidazole, N-vinylpyrrolidone, 2-vinyl-pyrrolidone, N-vinylpyrrolidine, 3-vinylpyrrolidine, N-vinylcaprolactam, N-vinylbutyrolactam, vinyloxolane, vinylfuran, vinylthiophene, vinylthiolane, vinyl-thiazoles and hydrogenated vinylthiazoles, vinyl-oxazoles and hydrogenated vinyloxazoles;

vinyl ethers and isoprenyl ethers; maleic acid derivatives such as maleic anhydride, methylmaleic anhydride, maleimide, methylmaleimide; and dienes, such as divinylbenzene.

The amount generally used of these comonomers is from 0 to 60% by weight, preferably from 0 to 40% by weight and particularly preferably from 0 to 20% by weight, based on the weight of the monomers, and the compounds here can be used individually or in the form of a mixture.

The polymerization reaction is generally initiated by known free-radical initiators. Among the preferred initiators are, inter alia, the az initiators well known to persons skilled in the art, e.g. IBN and 1,1-azobiscyclohexanecarbonitrile, and peroxy compounds, such as methyl ethyl ketone peroxide, acetylacetone peroxide, dilauryl peroxide, tert-butyl 2-ethyl-perhexanoate, ketone peroxide, methyl isobutyl ketone peroxide, cyclohexanone peroxide, dibenzoyl peroxide, tert-butyl peroxybenzoate, tert-butylperoxy isopropyl carbonate, 2,5-bis(2-ethylhexanoylperoxy)-2,5-dimethyl-hexane, tert-butyl 2-ethylperoxyhexanoate, tert-butyl 3,5,5-trimethylperoxyhexanoate, dicumyl peroxide, 1,1-bis(tert-butylperoxy)cyclohexane, 1,1-bis(tert-butylperoxy) -3,3,5-trimethylcyclohexane, cumyl hydroperoxide, tert-butyl hydroperoxide, bis (4-tert-butyl-cyclohexyl) peroxydicarbonate, mixtures of two or more of the abovementioned compounds with one another and mixtures of the abovementioned compounds with compounds that have not been mentioned but which can likewise form free radicals.

The amount frequently used of these compounds is from 0.01 to 10% by weight, preferably from 0.5 to 3% by weight, based on the weight of the monomers.

The weight-average molar mass M_{w} of the homo- and/or copolymers to be used according to the invention as matrix polymers can vary widely, and the molar mass here is usually matched to the intended application and to the mode of processing of the molding composition However, it is usually in the range from 20 000 to 1 000 000 g/mol, preferably from 50 000 to 500 000 g/mol, and particularly preferably from 80 000 to 300 000 g/mol, with no intended resultant restriction.

The mixtures can comprise conventional additives of any type. Among these are inter alia antistatic agents antioxidants, mold-release agents, flame retardants lubricants, dyes flow improvers, fillers, light stabilizers, UV absorbers, and organophosphorus compounds, such as phosphites or phosphonates, pigments, weathering stabilizers, and plasticizers. However, the amount of additives is subject to a restriction deriving from the intended application.

Among the preferred additives are dyes whose transmittance is at least 30% at 350 nm when dissolved in methyl methacrylate at a concenrtration of 0.01% by weight. Dyes of this type are known per se and are available by way of example with the trademarks ®Makrolex blue RR, ®Makrolex violet B, ®Makrolex violet 3R, ®Makrolex green 5B, ®Makrolex green G from Bayer, ®Sandoplast blue 2B, ®Sandoplast red BB, ®Sandoplast green G, from Clariant, ®Mikrolitviol B-K, from Ciba.

The inventive process is carried out with commercially available processing machinery. Single-screw and twin-screw extruders are suitable for the extrusion process. Vented extruders are preferably used.

The starting materials are usually introduced in pelletized form into the extruder. The materials are melted and extruded in a manner appropriate to the composition. The inventive mixture composed of from 65 to 95% of polymethacrylate, from 5 to 35% of polyethylene terepthhalate glycol and, if appropriate, from 0.001 to 5.0% of auxiliaries and additives is melted at from 160 to 300° C. and extruded to give semifinshed products. There can be conventional processing machinery downstream of the extruder. it has been found that a forming process further amplifies the pearl-luster effect. Forming processes such as thermoforming or pressure forming are particularly suitable. For thermoforming, the semifinished product is heated to from 140 to 190° C. and, using appropriate pressure, e.g. in vacuo at<1 bar, is placed into the desired shape. The material can also be further processed by means of pressure forming. For this, the extruded semifinished product is heated and, under pressures for example at 2.5 bar, pressed into a mold.

Processing by way of injection molding likewise leads to materials which have a pearl-luster effect.

The inventive mixture composed of from 65 to 95% of polymethacrylate, from 5 to 35% of polyethylene terephthalate glycol and, if appropriate, from 0.01 to 5.0% of auxiliaries and additives is introduced into an injection molding machine, melted at a temperature of from 200 to 280° C., and then injection-molded. The injection moldings exhibit a pronounced pearl-luster effect.

The inventive plastics products with pearl-luster effect have a wide field of application. They can be used in the construction sector, in automobile construction, in shipbuilding, and in aircraft construction, preferably in the fitting-out of interiors However, the pearl -luster effect leads to wide use for consumer articles, e.g. packaging of any type, storage devices (e.g. dishes, crates, cups, etc.), decorative materials, housing materials for electronic equipment (e.g. mobile telehnornes, organizers, etc. toys and office requisites.

The examples given below are provided for better illustration of the present invention but are not intended to restrict the invention on to the features disclosed herein.

### EXAMPLES

### Example 1

80% of polymethyl methacrylate molding composition (Plexiglass 7H molding compositions Röhm, Germany) are charged in pellet form to an extruder with 20% of polyethylene terephthalate glycol (Spectar Copolyester 14471, Kodak Eastman USA). A temperature of 165° C. is set in the feed zone. The mixture is melted and reaches a melt temperature of about 278° C. The melt is orocessed by way of a slot die to give a sheet whose thickness is 3 mm.

### Example 2

The sheets produced in example 1 are formed by means or pressure forming to give dishes. For this, the sheets are heated to 160° C. for about 9 min and pressed into a mold with a pressure of 2.5 bar.

### Example 3

The sheets produced in example 1 are formed to give dishes by means of thermoforming. For this, the sheets are heated to 175° C. for about 9 min and thermoformed in vacuo (<1 bar).

Dishes with pronounced pearl-luster effect are obtained in examples 2 and 3

What is claimed is:

1. A process for production of plastics products with pearl-luster effect by means of extrusion or injection molding, characterized in that a mixture composed of from 5 to 35% of polyethylene terephthalate glycol and from 65 to 95% of polymethyl methacrylate and, if appropriate, from 0.01 to 5.0% of auxiliaries and additives is prepared and the mixture is extruded and, if appropriate, formed or injection-molded to give a plastics product.

2. The process for production of plastics products with pearl-luster effect as claimed in claim 1, characterized in that dyes are present.

3. The process for production of plastics products with pearl-luster effect as claimed in claim 1, characterized in that from 65 to 95% of polymethacrylate, from 5 to 35% of polyethylene terephthalate glycol and, if appropriate, from 0.01 to 5.0% of auxiliaries and additives are extruded at a temperature of from 160 to 300° C. to give semifinished products

4. The process for production of plastics products with pearl-luster effect as claimed in claim 3, characterized in that the extruded semifinished products are heated and, under pressure, formed.

5. The process for production of plastics products with pearl-luster effect as claimed in claim 1, characterized in that from 65 to 95% of polymethacrylate, from 5 to 35% of polyethylene terephthalate glyco and if appropriate, from 0.01 to 5.0% of auxiliaries and additives are injection-molded at a melt temperature of from 200 to 280° C.

6. A mixture comprising from 65 to 95% of polymethacrylate and from 5 to 35% of polyethylene terephthalate glycol and, if appropriate, from 0.01 to 5.0% of auxiliaries and additives.

7. The use of plastics products with pearl-luster effect as claimed in claim 1 in the construction sector, in the automobile sector in, shinbuilding and in aircraft construction.

8. The use of plastics products with pearl-luster effect as claimed in claim 1 for packaging, decorative materials housing materials for electronic equipment, toys, office requisites.
